(19) United States
(12) Patent Application Publication
(10) Pub. No.: US 2010/0001927 A1
(43) Pub. Date: Jan. 7, 2010

(54) Helmet mounted modular night vision enhancement apparatus

(75) Inventors: Charles Hough, Alexandria, VA (US); Arthur Hastings, Stafford, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: United States of America, as represented by the Dept. of the Army

(21) Appl. No.: 11/034,367

(22) Filed: Jan. 13, 2005

(51) Int. Cl. G09G 5/00

(52) U.S. Cl. 345/8

(57) ABSTRACT

The invention is a modular system to mount various vision enhancing devices to a helmet. The invention allows for currently fielded imaging devices to be used as designed while at the same time provides a way to mount a new technology. This modular design concept consists of the currently fielded image-intensifying monocular mount, a new mounting bracket compatible with the currently fielded image-intensifying monocular, a helmet mounted display clip-on mount, and a clip-on electronics mount. The bracket would not only provide a means of attachment but also contain the cabling necessary for operation. The invention also consists of a clip on bracket for the HMD, necessary to view the thermal imagery, which can be placed over either eye. The design of this modular system allows the user to configure the helmet as deemed appropriate for the mission at hand.

### GOVERNMENT INTEREST

The invention described herein may be manufactured, used, sold, imported, and/or licensed by or for the Government of the United States of America.

### FIELD OF THE INVENTION

The present invention generally relates to helmet mounted vision enhancement devices and more particularly, to mounted night vision and infrared cameras.

### BACKGROUND OF THE INVENTION

With the advancements of infrared imaging and miniaturization of electronics, it is now conceivable to mount a low-power thermal imaging camera to the helmet of a soldier while not noticeably increasing his borne weight. Field tests have shown that some hostile threats, whether obscured by foliage or at too great a range, can be undetectable in image intensification systems, but clearly seen in thermal imaging systems. A helmet mounted system containing both an image intensifying device and a thermal imager would significantly increase the effectiveness of the solider.

Most of the current helmet mounted vision enhancement devices today are fixed so that they are not easily removable. While the cameras, etc. may be removed the mounting itself may not be. Thus, adding weight and inconvenience to the soldier.

Accordingly, there is a need in the prior art to develop removable and interchangeable helmet mounts for vision enhancement devices. The present invention addresses this need.

### SUMMARY OF THE INVENTION

One object of the present invention is to provide a removable and interchangeable helmet mounts for vision enhancement devices.

This and other objects of the invention are achieved by an assembly that allows for a soldier to directly view an image-intensifying device through either eye with the option of attaching a thermal imaging camera whose image output is viewed on a Helmet-Mounted Display (HMD). The HMD can be mounted on either side of the front of the helmet so the eye not actively using the image-intensifying device may view it. As an added function for varying mission parameters, the soldier has the ability to disconnect the image-intensifying device and solely mount the thermal imaging camera on the assembly. The mounting apparatus includes an helmet mounted assembly, an assembly slide attached to the helmet mounted assembly so that it may slide back and forth, a bracket to the imaging intensifying camera and/or a mount for the thermal imaging camera. The HMD attaches to the helmet separately over either eye. The assembly slide, bracket and thermal imaging camera mount each have interfaces in which are electrical contacts and video in/out contacts. The assembly slide only has a receiving port, the bracket has both a connecting and receiving ports, and thermal imaging camera mount only has a connecting port. Each of these ports can then be connected in series to complete the circuits.

### BRIEF DESCRIPTION OF THE DRAWINGS

The foregoing and other objects, aspects and advantages will be better understood from the following detailed description of the invention with reference to the drawings, in which:

FIGS. 1a-c are three dimensional views of the bracket component of the invention. FIG. 1a is a three-quarter front view. FIG. 1b is a three-quarter rear view. FIG. 1c is a top view.

FIGS. 2a-c are three dimensional views of the thermal imaging camera mount of the invention. FIG. 2a is a three-quarter front view. FIG. 2b is a three-quarter rear view. FIG. 2c is a bottom view.

FIGS. 3a and 3b are three dimensional views of the assembly slide of the invention. FIG. 3a is a three-quarter front view. FIG. 3b is a three-quarter rear view.

FIG. 4 is a three dimensional view of the components of FIGS. 1-3 configured for night vision applications only.

FIGS. 5a and 5b are three-dimensional views of the invention showing how it can be configured for the right or left eye.

FIG. 6 is a three dimensional view of the components of FIGS. 1-3 configured for both night vision and thermal imaging applications.

FIGS. 7a and 7b are three-dimensional views of the invention as mounted on the helmet showing how the invention can be configured for both night vision and thermal imager for either the right or left eye.

FIG. 8 is a three dimensional view of the components of FIGS. 1-3 configured for thermal imaging applications only.

FIGS. 9a and 9b are three-dimensional views of the invention showing how it can be configured for the right or left eye.

FIGS. 10a and 10b are three-dimensional views of the assembly slide of the invention showing the right and left electrical contacts of the slide.

FIGS. 11a and 11b are three-dimensional views of the bracket of the invention showing the male interface electrical contact and the receiving port electrical contact, respectively.

FIGS. 12a and 12b are exploded views of the slide and the bracket of the invention showing the interface between each.

FIG. 13 is a three-dimensional view of the thermal imaging camera's mounting and its electrical contact locations.

FIGS. 14a and 14b are exploded views of the slide, bracket, and mounting and the interface between each.

FIG. 15 shows the electrical contacts on the thermal imaging camera.

FIGS. 16-16d show how the mounting is coupled to the thermal imaging camera.

FIG. 17 shows the video out and video in connection between the thermal imaging camera and the mounting.

FIG. 18 shows the video out and video in connection between the mounting and the bracket.

FIG. 19 shows the video lead of the bracket.

FIGS. 20a and 20b show the video out and video in between the bracket and the assembly slide and an explode view of the interface between the bracket and the slide, respectively.

FIG. 21 shows the video out and video in between the assembly slide and the helmet mounted display.

FIG. 22 shows the invention stowed out of the soldier's field of view.

FIGS. 23a and 23b show a three dimensional detail of the bracket and a cross-section of bracket, respectively.

### DETAILED DESCRIPTION OF THE INVENTION

The invention provides soldiers with an interchangeable and removable assembly to attach a monocular image-intensifying device and a thermal imaging (IR) camera to a helmet. The design of this assembly allows for the soldier to directly view the image-intensifying device (which is sometimes referred to as the PVS-14) through either eye with the option of attaching a thermal imaging camera whose image output is viewed on a Helmet-Mounted Display (HMD). (PVS-14 is the Army product number for a particular kind of imaging intensifying camera. The invention, however, is not limited to this particular camera.) The HMD can be mounted on either side of the front of the helmet so the eye not actively using the image-intensifying device may view it. As an added function for varying mission parameters, the soldier has the ability to disconnect the image-intensifying device and solely mount the thermal imaging camera on the assembly. In this role, the soldier is capable of choosing with which eye to view display. Finally, if the soldier deems the use of “night-vision” technology unnecessary, the soldier may fold both the assembly system and the HMD vertically, completely out of view.

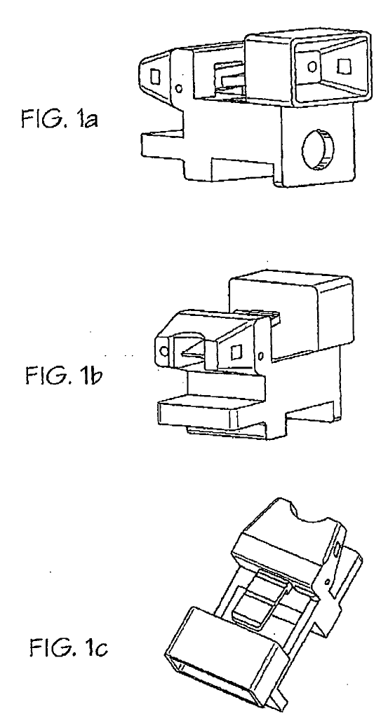

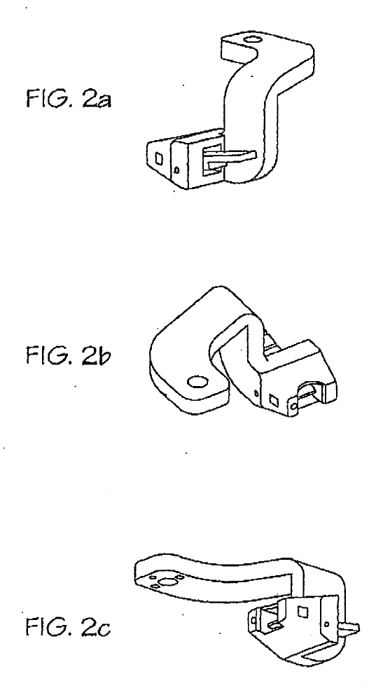

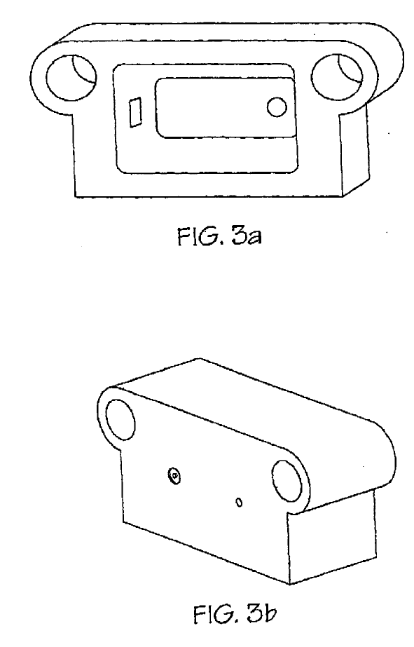

The new mounting assembly interfaces with the existing helmet mounted assembly for the PVS-14, which will keep the cost of upgrading old systems to a minimum. The only new parts are the PVS-14/IR Bracket (FIG. 1), the IR Camera Mount (FIG. 2), and the Assembly Slide (FIG. 3).

This system promotes a more effective, efficient, and survivable soldier due to its advantage of leveraging thermal imaging technology with imaging intensifying devices. With the ability to see both “night-vision” (thermal and imaging intensifying) technologies simultaneously, the soldier has a greater likelihood of detecting and destroying enemy targets.

The PVS-14/IR Bracket, IR Camera Mount, and the Assembly Slide can all be made out of either injection molded plastic, carbon fiber, or any other suitably hardened material for military operations.

The Modular Night Vision Enhancement Kit has various configurations; all of which are available at the discretion of the soldier. They are as follows.

### PVS-14-0nly

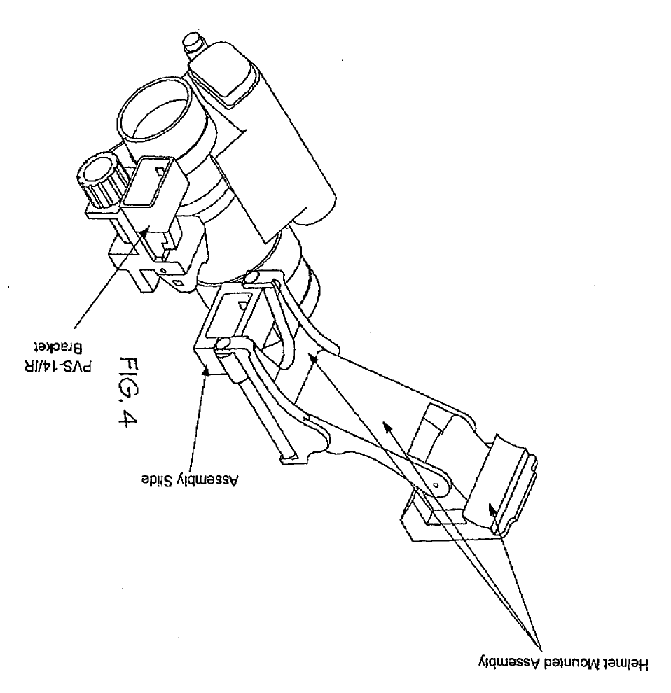

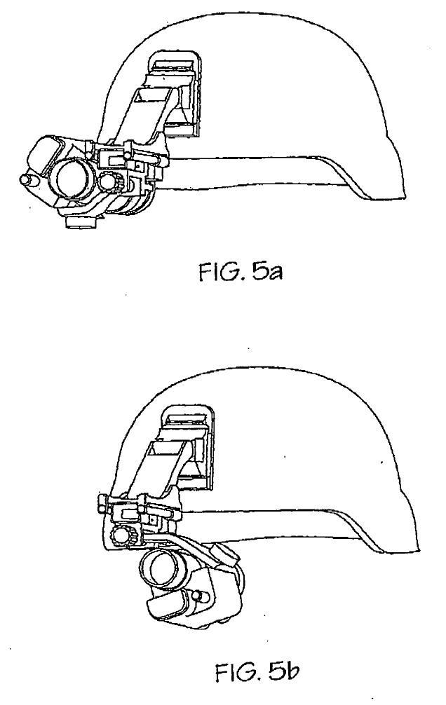

The invention may be configured with only the PVS-14. In this case, only the PVS-14/IR Bracket is attached to the Assembly Slide Receiving Port (FIG. 4). In this configuration the PVS-14 can be viewed through either eye (FIG. 5).

### PVS-14 and IR

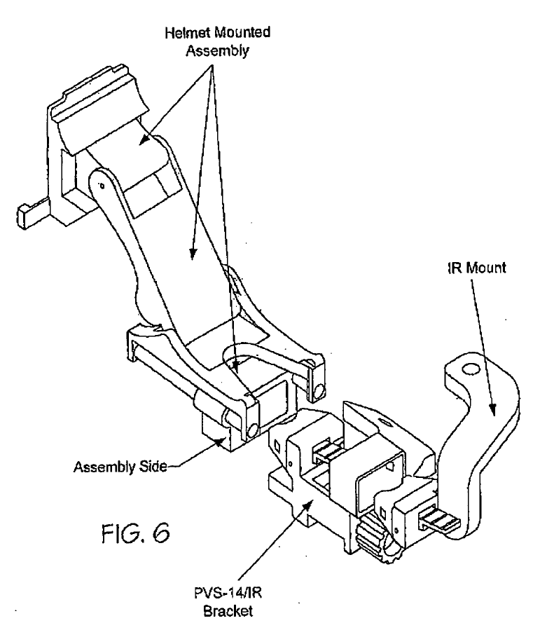

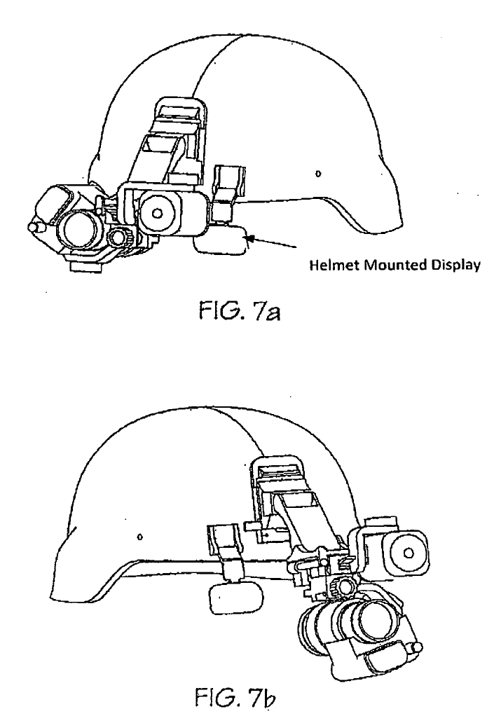

The invention can also be configured with the PVS-14 and IR Camera mounted at the same time. This set up requires the IR Camera to be attached to the IR Camera Mount which is plugged into the PVS-14/IR Bracket's Receiving Port. The PVS/14-IR Bracket is then plugged into the Assembly Slide Receiving Port. (FIG. 6) The soldier determines with which eye to view the PVS-14 and attaches the HMD over the other eye on the front of the helmet. (FIG. 7)

### IR-Only

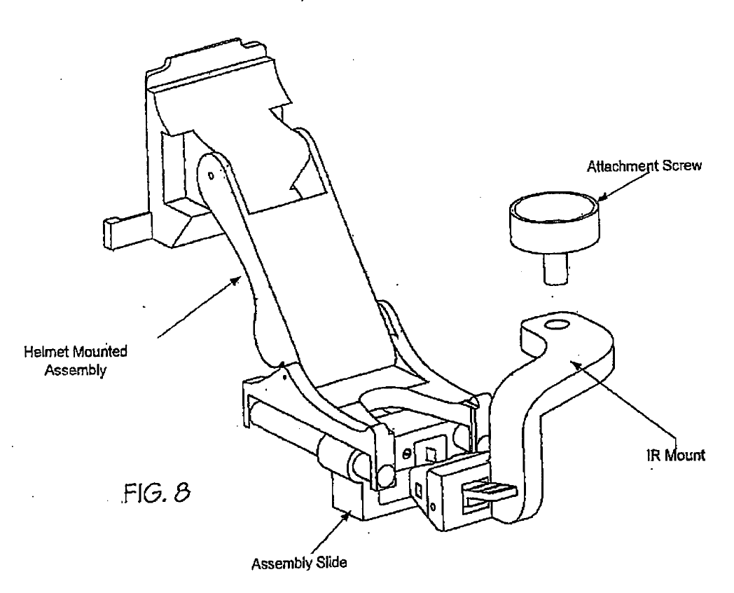

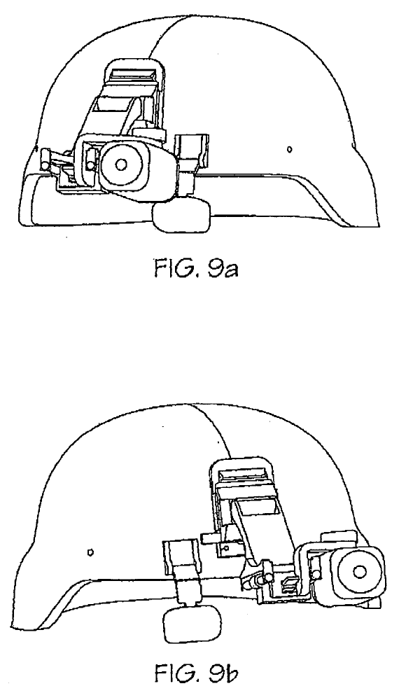

The invention can also be set up with only the IR Camera attached. In this situation, the IR Camera Mount is plugged directly into the Assembly Slide Receiver Port. (FIG. 8) The soldier then determines with which eye he would like to view the HMD. (FIG. 9)

The image-intensifying devices have a self-contained power source, while the thermal imager and the HMD require an external power source. This power source is mounted on the helmet and is able to be covered by the helmet's camouflaging material. The power cable lead is branched and one lead is run into two electrical contacts in the Receiving Port of the Assembly Slide and the other runs to the HMD.

In order to get power from the power source mounted on the soldier's helmet to the thermal imaging camera, a power cable must be run through the Assembly Slide, PVS-14/IR Bracket, and the IR Camera Mount. One design approach to give power to the thermal imager is described below.

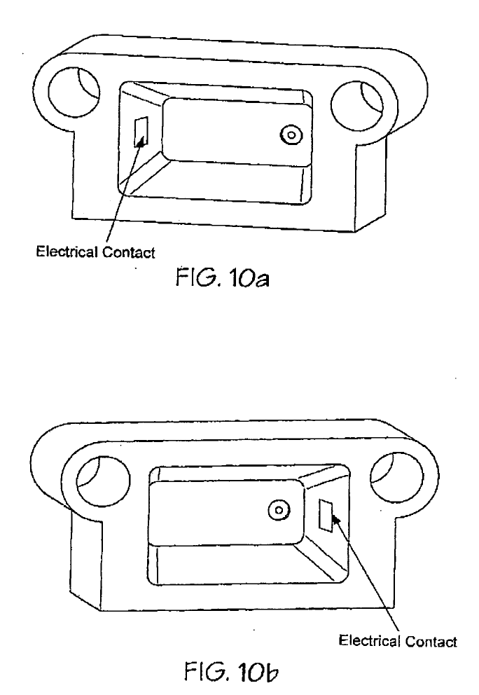

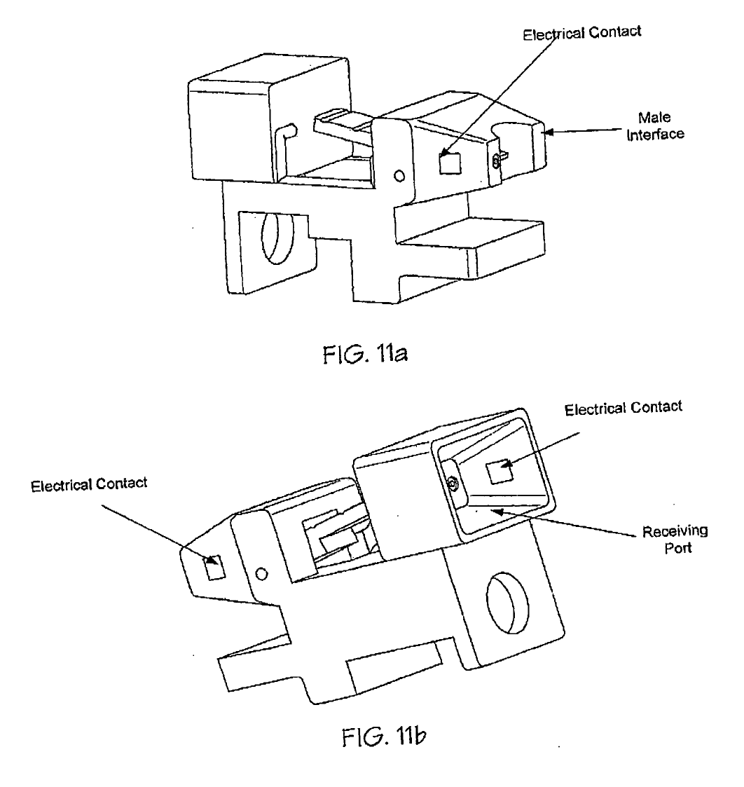

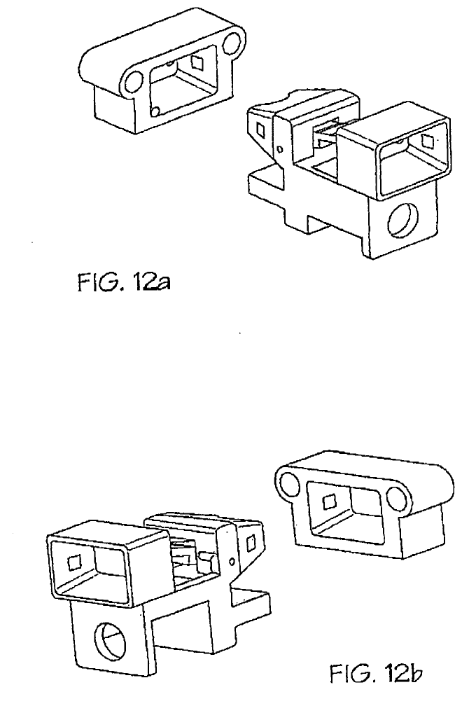

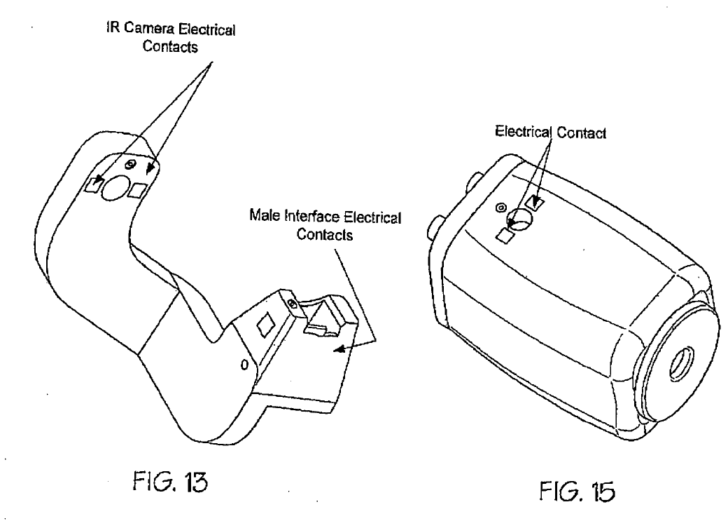

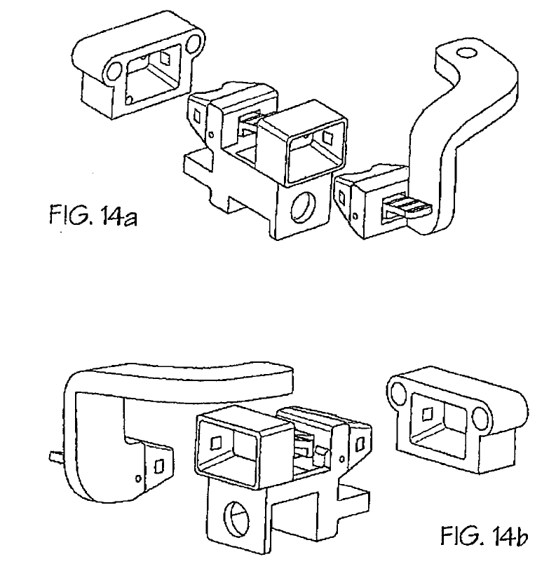

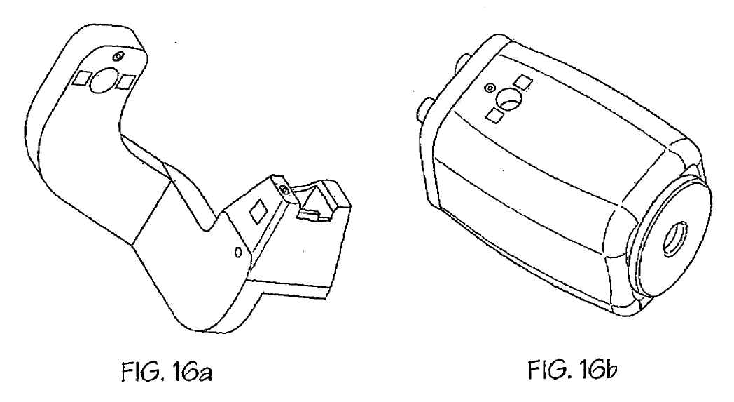

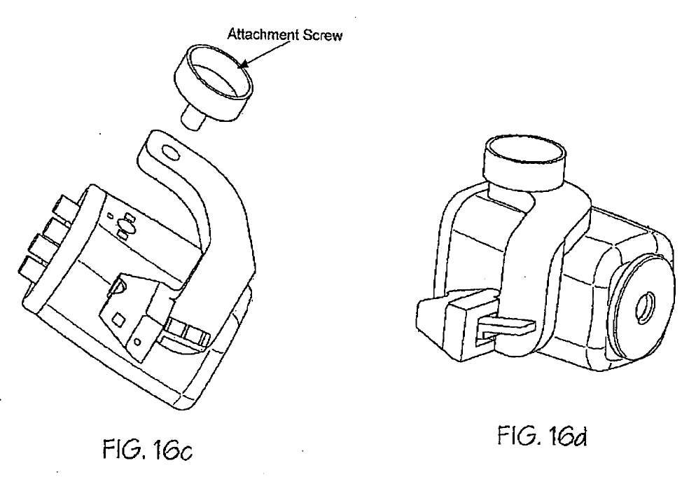

The lead from the power source is run into two electrical contacts in the Receiving Port of the Assembly Slide (FIG. 10). The PVS-14/IR Bracket has two sets of electrical contacts, one set on the Male Interface and the other in the Receiving Port (FIG. 11). The Assembly Slide contacts connect with the Male Interface contacts of the PVS-14/IR Bracket when the bracket is attached to the Assembly Slide (FIG. 12). The power lead is then run from the PVS-14/IR Bracket Male Interface to two electrical contacts in the Bracket's Receiving Port. The IR Camera Mount also has two sets of electrical contacts, one on the IR Camera Mount's Male Interface and the other on underside of the IR Mount (FIG. 13). The PVS-14/IR Bracket's Receiving Port contacts connect with the two electrical contacts on the IR Camera Mount's Male Interface (FIG. 14). The power leads are then run through the IR Camera Mount to two electrical contacts on the underside of the Mount that interface with two electrical contacts on the top of the IR Camera (FIG. 15). The IR Camera is attached to the IR Camera Mount with an attachment screw (FIG. 16).

In the event that the soldier has chosen the IR-Only configuration of the invention, power is given to the IR Camera in the following way. The lead from the power source mounted on the helmet is run into the two electrical contacts in the Receiving Port of the Assembly Slide. The two'electrical contacts in the Receiving Port of the Assembly Slide line up and connect with the two electrical contacts on the IR Camera Mount Male Interface. The power is then run by wire through the IR Camera Mount to two electrical contacts that interface with the IR Camera when it is mounted to the IR Camera Mount.

The thermal imaging camera requires the imagery to be viewed on a separate helmet mounted display. This requires that the video signal from the imager must be run through the IR Camera Mount, the PVS-14/IR Bracket, and the Assembly Slide. The video signal is then wired to the HMD, which has the capability to be mounted for viewing by either eye.

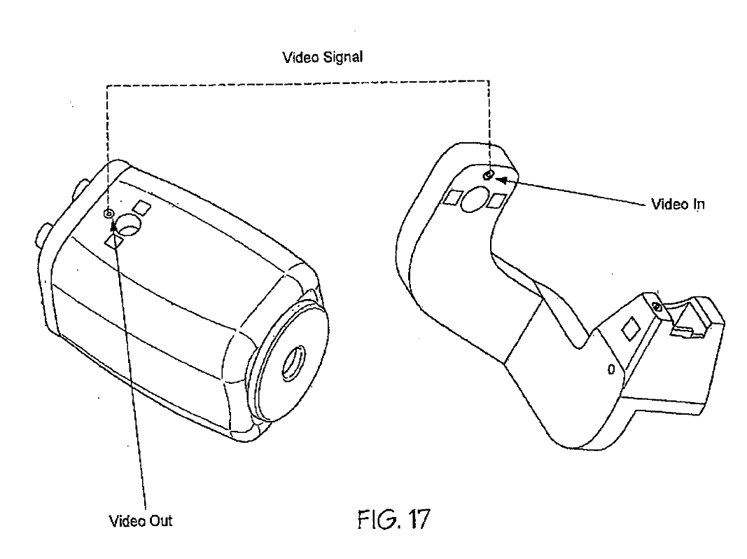

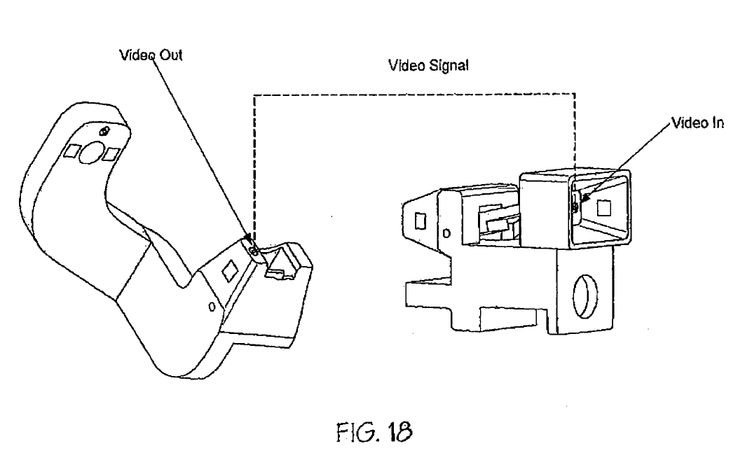

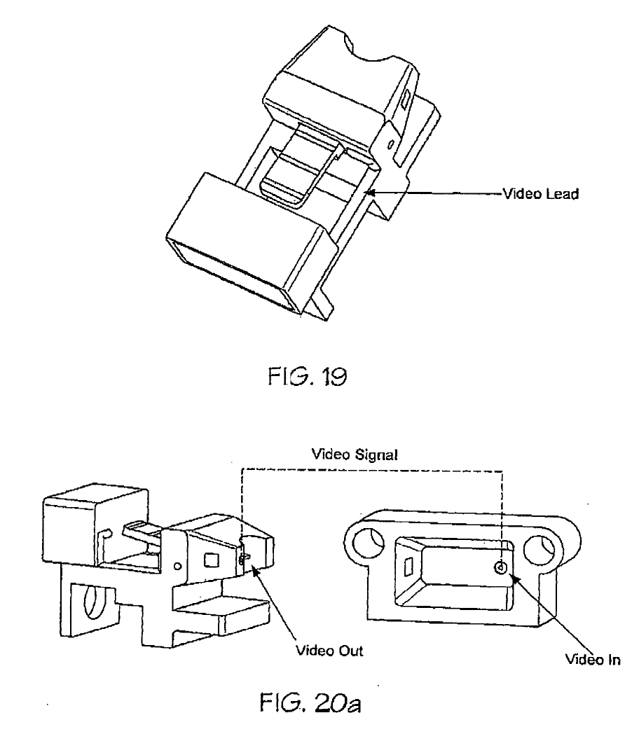

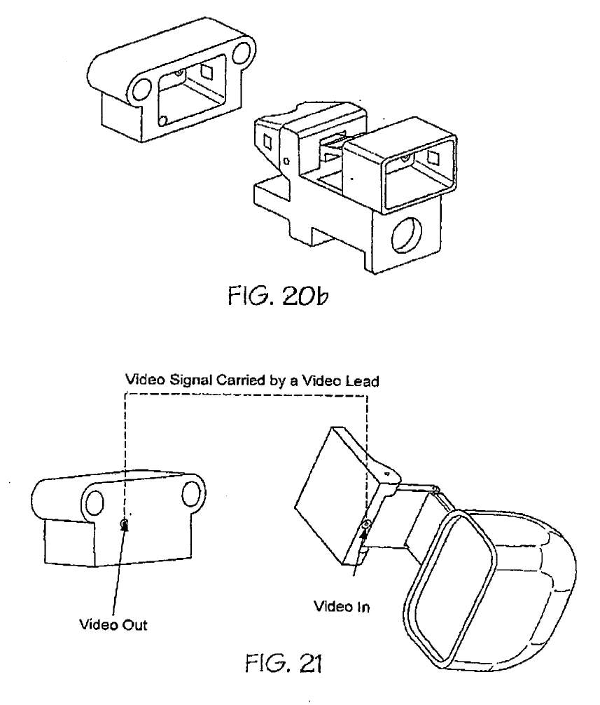

To get the video output from the thermal imager to the HMD the video signal will travel the following path. The signal will go from the video-out on the IR Camera to the video-in on the IR Camera Mount (FIG. 17). A video lead is then run down the IR Camera Mount into the video-out in the back of the IR Camera Mount's Male Interface. The video-out in the IR Camera Mount's Male Interface will plug into the video-in of the PVS-14/IR Bracket (FIG. 18). The PVS-14/IR Bracket has a video lead that runs between the bracket's video-in and video-out connectors (FIG. 19). The PVS-14/IR Bracket's video-out plugs into the video-in of the Assembly Slide (FIG. 20). Finally, the signal runs from the Assembly Slide's video-in to the Assembly Slide's video-out and then the video lead is run into the HMD's video-in (FIG. 21).

If the soldier has configured the invention in the IR-Only arrangement, the IR video imagery will be displayed in the following way. The IR Camera's video-out will plug into the IR Camera Mount's video-in. The IR Camera Mount's video-out will plug into the Assembly Slide's video-in. From the Assembly Slide's video-in, the video signal will go through to the Assembly Slide's video-out to the HMD's video-in interface, and then the image will be displayed to the soldier.

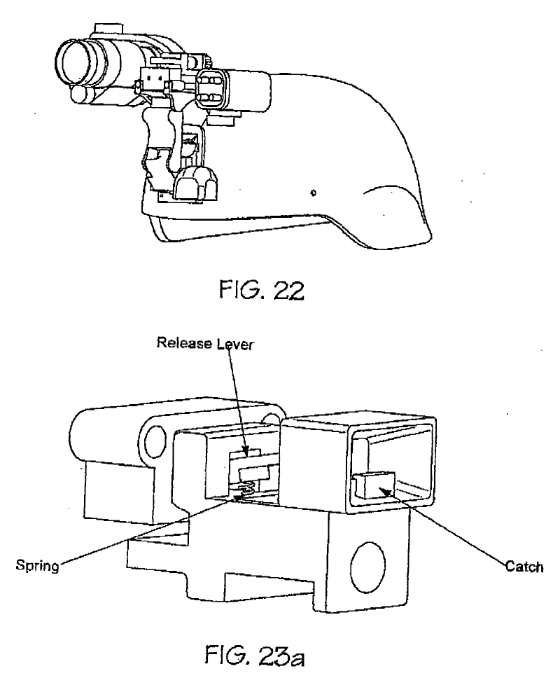

Both the invention and the HMD can be stowed out of the field of view of the soldier (FIG. 22). This is especially necessary when the soldier has configured the invention in the PVS-14-0nly mode, which does not require the HMD. The soldier simply folds the HMD vertically and the display is above the bill of the helmet and safely out of view.

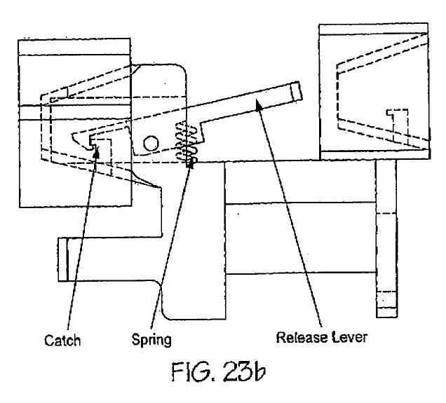

All of the pieces of the invention are attached using the same latch mechanism. Both the IR Camera Mount and the PVS-14/IR Bracket have a spring loaded Release Lever which grips a friction fit Catch. These catches are located inside the Assembly Slide's Receiving Port for the PVS-14/IR Bracket and in the Receiving Port of the PVS-14/IR Bracket for the IR Camera Mount. The soldier simply pushes down on the Release Lever, which clears the Lever from the Catch and then simply pulls the part out of the receiving port. (FIG. 23)

The modular design allows for numerous configurations to be chosen by the individual soldier. With the ability of the mounting system to be easily customized by the soldier, it allows him to take full advantage of the available technology to accomplish varying mission objectives.

1. A modular vision enhancement apparatus comprising:
a helmet mounted assembly attached to a helmet and having movable components so that the helmet mounted assembly can be lifted from view;
an assembly slide attached to the helmet mounted assembly so that the assembly slide can slide back and forth, the assembly slide having a receiving port with a video connection and an electrical power connection; and
a bracket for an image intensifying camera, the bracket having both connecting and receiving ports, each port having a video connection and an electrical power connection, wherein the bracket's connecting port can be connected in series with the assembly slide's receiving port.

2. The apparatus of claim 1 further comprising:
a mount for a thermal imaging camera, the mount having a connecting port with a video connection and an electrical power connection, wherein the mount's connecting port can be connected in series with the bracket's receiving port to complete electrical and video circuits for the thermal imaging camera; and
a helmet mounted display to view the image from the thermal imaging camera, the helmet mounted display being separately attached to the helmet.

3. The apparatus of claim 2 wherein the thermal imaging camera is attached to the mount with an attachment screw.

4. The apparatus of claim 1 wherein the apparatus is made from injection molded plastic, carbon fiber, or a hardened material acceptable for military operations.

5. The apparatus of claim 2 wherein the apparatus is made from injection molded plastic, carbon fiber, or a hardened material acceptable for military operations.

6. A modular vision enhancement apparatus comprising:
a helmet mounted assembly attached to a helmet and having movable components so that the helmet mounted assembly can be lifted from view;
an assembly slide attached to the helmet mounted assembly so that the assembly slide can slide back and forth, the assembly slide having a receiving port with a video connection and an electrical power connection; and
a mount for a thermal imaging camera, the mount having a connecting port with a video connection and an electrical power connection, wherein the mount's connecting port can be connected in series with the assembly slide's receiving port to complete electrical and video circuits for the thermal imaging camera; and
a helmet mounted display to view the image from the thermal imaging camera, the helmet mounted display being separately attached to the helmet.

7. The apparatus of claim 6 wherein the thermal imaging camera is attached to the mount with an attachment screw.

8. The apparatus of claim 6 wherein the apparatus is made from injection molded plastic, carbon fiber, or a hardened material acceptable for military operations.
